(19) United States
(12) Patent Application Publication
(10) Pub. No.: US 2006/0104803 A1
(43) Pub. Date: May 18, 2006

(54) Method and device for exchanging transport elements

(76) Inventors: Georg Wanninger, Weiding (DE); Rupert Janker, Rattiszell (DE)

Correspondence Address: Russell D Culbertson;The Culbertson Group, Suite 420, 1114 Lost Creek Boulevard, Austin, TX, 78746, US

(21) Appl. No.: 10/534,856

(22) PCT Filed: Nov. 14, 2003
(86) PCT No.: PCT/DE03/03759

§ 371 Date: May 13, 2005

(30) Foreign Application Priority Data
Nov. 15, 2002 (DE) 102 53 602.3
Feb. 13, 2003 (DE) 203 02 336.6

(51) Int. Cl. B65G 7/08

(52) U.S. Cl. 414/814

(57) ABSTRACT

The invention concerns a method and apparatus for rearrangement of products stacked on transport elements and replacement of transport elements, in which the stack is grasped and stabilized at least on two opposite sides by clamping jaws, in that a foot element carrying the transport element can be pivoted out and the transport element removed from under the stack, while this stack is held in the upright or sloped position.

### CROSS-REFERENCE TO RELATED APPLICATION

The Applicants claim the benefit, under 35 U.S.C. § 119(a)-(d), 365(a), and/or 365 (b) of PCT International Application No. PCT/DE 03/03759, filed November 14, 2003, entitled METHOD AND DEVICE FOR EXCHANGING TRANSPORT ELEMENTS, which claims the benefit of German Patent Application No. 102 53 602.3 filed Nov. 15, 2002 and German Utility Model Application No. 203 02 336.6 filed Feb. 13, 2003. The entire content of the PCT International Application No. PCT/DE03/03759 is incorporated herein by this reference.

### TECHNICAL FIELD OF THE INVENTION

The present invention concerns a method and apparatus for rearrangement of product stacks and changing of transport elements that are situated especially beneath stacked products.

### BACKGROUND OF THE INVENTION

Devices for rearrangement of stacks and replacement of transport elements beneath stacked products are known from the prior art. They are intended to solve the problem of replacing in a simple manner a specific transport element, for example, a Euro pallet under a stack lying on it with another transport element without rearranging the stack or otherwise having to disassemble and reassemble it. In particular, methods are known in which the stack is tilted slightly or placed entirely on the side in order to unload the pallet and finally replace it.

This procedure entails the drawback that the stack during movement can easily fall apart. Proper rearrangement and realignment of the stack is not possible.

GB 2 187 433 A describes a pallet handling apparatus in which stacked products are clamped for handling between a pallet and an opposite stabilization device. U.S. Pat. No. 3,123,232 describes a pallet change system within a conveyor system, in which a stack supported on its top is tilted slightly while the pallets are changed. An apparatus for handling objects can be deduced from DE 36 11 584 A1, in which a stack, also clamped between the floor and a cover plate, is rotated around a horizontal axis. DE 28 43 578 concerns a load transfer unit, which, after arrangement of a new pallet on the top of the stack and reversal of the stack as well as the pallet, makes a new support pallet. A conversion apparatus is known from DE-AS 1 920 979, which also permits its supporting pallet to be unloaded and replaced by tilting a stack.

### SUMMARY OF THE INVENTION

The task of the invention is therefore to present a method and apparatus for replacement of transport elements that permit simple and shape-stable handling of the stack and at the same time can be carried out quickly and cost-effectively.

This task is accomplished by a method according to claim 1 and a reloading apparatus according to claim 7.

The invention starts from the finding that a stack can be securely guided during replacement of the transport elements, if it is grasped on at least two opposite sides by clamping jaws that impart increased stability to the stack. In this way it is advantageously ensured that the stack cannot collapse on these sides while it is being moved. It is then assumed that a stack with stacked products lies on the transport element. The stack with the transport element should lie according to the invention on a foot element so that the stack is supported by the transport element and this is supported by the foot element.

The method according to the invention then occurs according to the following steps:

a) Fastening of a product stack (S) resting on a first transport element (T1) between the first transport element on the lower end of the stack (S) and a fastening cover (D) provided on the opposite upper end of the stack (S), the first transport element lying on a foot element (F),

b) Clamping of the stack between at least two additional side surfaces opposite each other by at least two clamping jaws (K),

c) Pivoting and/or movement of the foot element (F) away from the bottom of stack (S) so that the first transport element is released,

d) Exchange of the first transport element (T1) with a second transport element (T2),

e) Reversal of the movements of the foot element (F) mentioned in step c) so that the second transport element (T2) is placed against the lower end of the stack (S).

f) Loosening of the fastenings and clamps according to step a) and b).

According to process step a) a stack of products lying on first transport element is to be initially fastened, especially on its top. For this purpose a fastening cover is mounted from the top on the stack or pressed against the top of the stack by a stipulated amount. The stack is fastened in this way between the fastening cover and the transport element on which the stack rests.

According to the invention the stack is then clamped on two additional sides (right and left or front and back side) by corresponding clamping jaws. These clamping jaws therefore approach each other from the right and left until they lie against the stacked product and compress it by a selectable amount so that the stack acquires a stable lateral guiding. This advantageously ensures that the stack does not collapse during replacement of the transport element, since lateral guiding can reliably prevent such collapse with appropriate dimensioning of the clamping jaws.

According to process step c) the foot element is now to be moved away from the bottom of the stack. This can occur by pivoting the foot element out around an axis running essentially horizontally. As an alternative or in addition, it is also possible to continue to move the foot element in a linear movement from the bottom of the stack, i.e., especially in a direction Z that should characterize the essentially vertical alignment of the stack. In each case the movement of process step c) should serve to release the first transport element and unload it so that it is no longer clamped between the foot element and the stack and can therefore be freely removed.

Removal of the transport element and replacement with a new transport element is accomplished according to process step d). Removal and replacement can only occur if the first transport element is actually unloaded from a stack. This can be achieved by compressing the clamping jaws from the right and left on the stack so that secure holding of the stack ensures that falling out of the stack products downward during removal of the transport element is avoided. Depending on the type of stacked product and the clamping effect by the clamping jaws, a further process step can be required, which is described below.

Process e) describes reversal of movement of the foot element. After the new transport element has replaced the old one and therefore has been inserted between the foot element and the bottom of the stack, the foot element must be returned to its initial position for reliable support of the stack. This occurs by pivoting or moving the foot element back in the direction toward the bottom of the stack.

The stack, which did not change its essentially vertical alignment after the aforementioned process steps, is now freed again from the laterally applied clamping jaws and the fastening cover on the top of the stack can also be removed, so that it can freely rest on the new transport element. The new transport element with the stack can be lifted from the foot element with a forklift or other appropriate machine and handled further.

These process steps therefore permit rearrangement of the stack and simple and reliable replacement of a first transport element with a second one without threatening the stability of the stack.

In a particularly advantageous variant of the invention, pivoting of the entire stack around an essentially horizontal axis into a tilting position occurs between process steps b) and c). This means that the stack together with the laterally arranged clamping jaws, the fastening cover positioned on the top and the transport element or foot element bordering it on the bottom is completely brought into an oblique position. This has the advantage that the stack additionally loads at least a lateral guide with its own weight by a selectable amount and therefore unloads the transport element. This lateral guide element can either be one of the two clamping jaws, but pivoting into a back position is also inconceivable. The stack then is sloped toward a rear wall on which the two laterally arranged clamping jaws are arranged essentially at a right angle. In this manner the stack therefore lies against the rear wall while it is also fastened in this direction as before by the two lateral clamping jaws.

The degree of pivoting movement, i.e., the angle by which the entire stack is to be tilted, is freely selectable and guided according to the necessary unloading of the transport element. Even a tilting movement up to horizontal, i.e., by 90° or even to 180° is conceivable. In this new, preferably horizontal tilting position, the already described process step c) is connected in order to unload the bottom of the stack again, i.e., the transport element itself, and replace it. The stack therefore lies in an oblique tilted position during the actual replacement process.

After replacement of the transport element by corresponding retraction of the foot element, as a supplement to the original process, a re-pivoting movement of the stack naturally also occurs into its essentially upright position so that the new transport element finally can be fully loaded again. At the latest, on release of the lateral clamping jaws and with lifting of the fastening cover, the stack again rests fully on the now new transport element, which can again be lifted in appropriate fashion from the foot element and moved.

The tilting movement according to the invention can occur, on the one hand, so that the pivot axis is aligned essentially parallel to a side surface of the stack (i.e., a rear wall or one of the two side walls). However, as an alternative, pivoting around an axis that runs essentially horizontally and also assumes an angle ≠90° relative to the side surface of the stack is also conceivable. This means that the stack is tilted “on its corner” so that the stack weight is distributed essentially onto two adjacent side surfaces of the stack. In the tilted position one of the four above-mentioned longitudinal edges of the stack faces downward, while during a pivot movement around a pivot axis aligned parallel to one side surface, the two adjacent side surfaces are essentially perpendicular.

Especially in the horizontal alignment of the tilted stack, the stack can be divided at any location by introducing a separation element, which can also be a transport element, between two layers of the stack elements. The elements of the stack parts being formed can then be easily pushed in the horizontal direction in order to create the necessary gap for the separation or transport element. Optionally the fastening cover can be released for this purpose from the top of the stack or loosened in order to permit horizontal displacement of the stack elements or stack layers.

After pivoting back into the initial position, the stack now has aligned side surfaces (depending on the corrective measure performed), a replaced lower transport element or additional intermediate elements with which the stack was divided into individual parts. Ideally, the inserted intermediate elements are also transport elements so that they can be easily lifted, for example, with a forklift. The originally continuous stack can be divided without particular expense into individual stacks on this account, depending on the transport elements inserted in the horizontal tilting position.

In an advantageous variant of the invention, the rear wall is divided into at least two wall elements that can be moved relative to each other in their longitudinal and/or transverse direction. Because of this design feature a situation is advantageously achieved in which a stack brought into the horizontal tilting position can be divided into several parts merely owing to the fact that the wall elements can be pushed away from each other so that a natural gap is formed between them. In the tilted position one part of the stack rests on one of the two wall elements, while the other part of the stack lies on the other wall element. If these two wall elements are now pulled apart, the stack is divided and permits insertion of a separation element or a transport element. Separation of the stack can then occur in the longitudinal direction of the original stack so that several “narrower” stacks are produced with the original stack height. Division can also occur transverse to the original stack longitudinal direction, when the rear wall is correspondingly divided. Finally, a combination of the two division variants is also possible, so that a stack can be simultaneously divided lengthwise and crosswise.

Division of the rear wall into more than two wall elements is naturally also conceivable. Separation of the wall elements by corresponding drives and their optional control can also be automated.

For movement of the wall elements relative to each other, the side clamping jaws can be released in order to be able to easily move the stack of products with the corresponding wall element.

The reverse procedure also reasonably applies for the moveable wall elements. Two stacks situated one on the other, each of which is supported by a transport element, can then be easily rearranged in the horizontal position to a continuous stack. For this purpose the wall elements would be separated from each other so that the two stacks initially are loosened from each other in horizontal alignment. After removal of the transport element of the upper stack and subsequent movement of the wall elements together, the bottom of the upper stack would come to lie directly on the top of the lower stack. After re-pivoting of the now complete stack into the upright position, the newly formed complete stack could therefore be transported further.

Another advantageous variant of the method proposes that some of the aforementioned process steps can be carried out simultaneously, at least in part. This advantageously saves time and therefore also costs. For example, positioning of the fastening cover and clamping with the two lateral clamping jaws can occur simultaneously. It is even conceivable to conduct these two movements together with the pivot movement of the entire stack so that time is again saved. The opposite movements with which the stack is ultimately brought back into its initial position can also be carried out together accordingly, at least in part, in order to save time and costs.

An apparatus for execution of the aforementioned method initially provides for a rear wall with a lower and upper end. The rear wall should extend in a Z direction in which the Z direction and therewith the rear wall should initially be aligned vertically in an initial position of the stack. The Z direction is linked in the following to the rear wall so that a pivot movement of the rear wall should simultaneously mean a pivot movement of the Z direction.

A foot element designed to accommodate a first transport element should be adjacent to the lower end of the rear wall. In the simplest case the foot element forms a right angle with the rear wall, but a different angle is also conceivable in principle. The foot element is then pivotable around a pivot axis running parallel to the rear wall and perpendicular to the Z direction and/or can be moved in the Z direction toward or away from the stack. Because of this moveability of the foot element, release of the transport element, which is initially clamped between the foot element and stack, is made possible.

A fastening cover that should be moveable parallel to the rear wall in the Z direction is to be arranged on the upper end of the rear wall. As a supplement or alternative it is also conceivable to make this fastening cover pivotable, so that it can be pivoted from the top on the stack around a pivot axis running parallel to the rear wall and perpendicular to the Z direction. The purpose of this fastening cover is fastening of the stack, especially the components positioned on the very top. In particular, when the stack is in an oblique position the uppermost components are securely held. According to the invention at least two lateral clamping jaws are provided that grasp the stack on two opposite sides and optionally compress it by a selectable amount. Because of these clamping jaws, the stack, as described previously, experiences good lateral guiding through which collapse of the stack during replacement of the transport element is avoided.

According to the invention the foot element arranged beneath the stack can then be moved away or pivoted so that the transport element can be freely removed. A prerequisite for this again is internal stability of the stack, which is influenced by the clamping function of the clamping jaws.

It is naturally also conceivable to provide clamping jaws on all four side surfaces of the stack instead of two, so that the stack is securely grasped and stabilized essentially all the way around.

An advantageous variant of the repositioning device according to the invention proposes that the entire apparatus be pivotable around a tilting axis running parallel to the rear wall and essentially horizontally from an initial position into a tilted position. As already described for the process, additional loading of the side surfaces of the stack stabilized by the clamping jaws is achieved on this account, whereas the lower transport element and foot element are relieved with increasingly oblique position. With appropriate arrangement of this pivot axis the transport element is then additionally raised by a certain height, which is ergonomically advantageous for the work personnel carrying out the exchange.

As an alternative to pivotability of the apparatus it is also conceivable to raise essentially vertically by a certain height the stack with its clamping jaws, rear wall, fastening cover, transport element and foot element. This permits the pivoting or travel movement of the foot element in order to release the transport element. The actually required lifting height is then guided according to the pivot or travel range that the foot element requires while it is moved away from the bottom of the transport element. The exclusively vertical movement of the stack and the subsequent movement of the foot element out, as already described, is then useful and possible, if the stack is stabilized merely by the clamping jaws so that even during removal of the transport element the individual components of the stack do not collapse downward. The lifting movement advantageously permits ergonomically comfortable work and technically simple design.

A combination of the two features is naturally also conceivable so that the stack can both be tilted around a horizontal axis and raised in the vertical direction. In this way the ergonomic and spatial requirements are ideally adjusted to each other and the apparatus permits replacement of the transport elements in the tilted or upright stack position, depending on the condition of the stack (internal stability).

An advantageous variant of the invention, similarly to the process just described, proposes a rear wall dividable (even several times) in its longitudinal and/or transverse direction in order to be able to divide the stack lying on it in a tilted position into several parts in simple fashion. By separation of the wall elements, the stack is divided and insertion or removal of the separation element or the transport element is possible.

With particular advantage the clamping jaws can be released from the side surfaces in any position of the stack, as required, or pressed against them. A situation is therefore advantageously achieved in which the side surfaces of the stack can only be unloaded where access to the stack (for example, for alignment of the side surfaces or insertion of the transport element) is required.

A particularly advantageous variant of the invention proposes that the clamping jaws have at least one balancing element to compensate for unevenness in the side surface. This balancing element serves to at least partially fill up uneven areas in the side surfaces so that all elements of the stack are supported equally well. An elastic balancing element works here, which, when positioned on the side surface of the stack, adjusts or fills in any offset of the elements or gaps in the surface. A cushion-like element or a material made soft in some other way, which, on approaching the side surface, assumes the shape of the surface as well as possible, is conceivable here. In addition, this type of balancing element offers protection for the elements of the stack, which are gently grasped with it and protected against possible tipping or shifting.

In an advantageous variant of the invention this type or a comparable balancing element is also provided for the fastening cover. The stack is then fastened on its top by the cover so that the balancing element adjusts to unevenness on the top of the stack. In particular, in incompletely layered stacks or partially broken down stacks in which individual elements of the uppermost cover layer are missing, a complete and secure support of the entire top of the stack can be achieved via the balancing element. The balancing element is then arranged similarly to the clamping jaws on the side surfaces between the fastening cover and the top of the stack.

An advantageous variant of the invention proposes that the balancing element of the fastening cover and/or the balancing elements on the clamping jaws be designed as an airbag or cushion. The airbag has the advantage that by inflation it adjusts its form directly to the corresponding side or surface of the stack without additional mechanical movement of the clamping elements or the hold-down being necessary. Moreover, the pressure or stabilization force can be selected beforehand through the pressure in the airbag. By sudden relaxation of the airbag, the exposed surfaces of the stack are quickly released again without the requirement for mechanical movement.

In contrast to this the technically less demanding cushion offers the possibility of being mounted permanently and free of maintenance directly on the clamping jaws or fastening cover. Merely by moving the hold-down or clamping elements on the corresponding surface of the stack, the cushion is forced into any recesses or unevenness of the stack surface and therefore stabilizes the corresponding surface overall. So stabilized, the stack can be aligned and tilted more stably.

The foot element in an advantageous variant of the invention can be pivoted and/or moved both in the upright and tilted position and also in any position in between. In this way different minimum slopes can be adjusted per stack condition, in which the foot element is to be moveable in each case. Because of this, maximum flexibility is offered during reloading of a variety of stacks or their transport elements.

A particular advantageous variant of the invention proposes that the laterally arranged clamping jaws can be pivoted toward the side surfaces of the stack or away from them by a pivoting movement. This can be accomplished with simple technical means and saves manufacturing costs and reloading time. The pivot axis of the clamping jaws is then preferably arranged in the Z direction and positioned, for example, in the region of the rear wall on the right and left.

As an alternative or in addition to this, it is also proposed that the clamping jaws can move linearly toward the sides of the stack. The clamping jaws are then moved essentially at right angles to the Z direction in an X direction toward the stack. Because of this, different stack widths can advantageously be grasped so that the versatility of the apparatus is increased. In particular, an apparatus is conceivable in which on each side the actual clamping jaw carries frames arranged around a pivot axis running in the Z direction in which this clamping jaw is arranged linearly moveable in contrast to the frame. Initially this permits pivoting of the two-sided clamping jaw so that the clamping jaws are initially arranged parallel to the side walls of the stack. In the next step the clamping jaws can then be moved toward the stack sides linearly at a right angle to the Z direction in order to secure the stack itself.

During opposite movement to release the stack, back-pivoting can immediately occur in order to release the stack for further transport. Reverse movement of the clamping jaws in the linear direction relative to the mentioned frame can then occur at a later point that is not time-critical.

However, an exclusively linear movement of the clamping jaws is also conceivable, so that a pivot movement is not prescribed at all. In this manner the mechanical expense is kept within limits so that the manufacturing costs are reduced.

Another advantageous variant of the invention proposes a vibrating element with which the stack can be placed in vibration, preferably in the tilted position for realignment of individual elements of the stack. The vibrating element is designed so that the reloading apparatus at least in the region of the back wall vibrates or is rocked. Unevenly layered elements or gaps between elements or an offset on the outside surfaces can be eliminated due to the fact that the individual elements slide relative to each other by vibrating and can therefore form a tighter connection. Optionally the pressure forces of the fastening cover or the clamping jaws or balancing elements can be reduced so that realignment of the elements of the stack is facilitated during vibration.

After realignment the clamping jaws and/or fastening cover can be pressed onto the stack again with increased pressure force in order to stabilize it in this compact form. By subsequent tilting movement back into the upright position, the stack is prepared for further transport in this homogeneous and compact form.

The vibrating element can be implemented for example via an eccentric or otherwise moved flyweight. Several vibrating elements are also conceivable at different locations of the reloading apparatus.

An advantageous variant of the invention is also characterized by the fact that the pivot movement occurs around about 180°, i.e., the stack overall can be turned upside down. In particular, it is therefore possible to replace a transport element provided beneath a stack by placing an additional transport element on top of the stack and then rotating the stack 180° around a horizontal axis. The transport element that formerly was on the top will then become the loaded lower transport element on which the stack rests. The previously lower transport element now lies unloaded on the new top of the stack and can be removed.

The tilting movement by 180° preferably occurs around an axis that is situated roughly in the region of half the stack height. Such an apparatus is particularly suitable for a stack in which the stack arrangement is irrelevant, i.e., the individual elements and therefore the stack could also be stacked upside down.

An advantageous variant of the invention also proposes that, for movement of the components of the reloading apparatus, drives be at least partially provided in order to automate replacement of the transport elements and rearrangement of the stacks at least partially. For this purpose a control is advantageously used that operates or coordinates the individual drives. These can be hydraulic drives, linear drives, pneumatic drives or also other, especially motor drives.

Additional advantageous variants are apparent from the dependent claims.

### BRIEF DESCRIPTION OF THE DRAWINGS

A variant of the invention is described below by means of figure examples. Shown are:

FIG. 1, a perspective view of the reloading apparatus according to the invention in an initial position A;

FIG. 2, a side view of the reloading apparatus according to FIG. 1;

FIG. 3, a top view of the reloading apparatus according to the FIG. 1 and FIG. 2;

FIG. 4, the reloading apparatus in a tilted position B;

FIG. 5, a perspective front view of the reloading apparatus in initial position A;

FIG. 6, a perspective oblique view of tilting position B;

FIG. 7, a perspective oblique view of an intermediate position;

FIG. 8, a simplified side view for both positions A, B and

FIG. 9, a simplified front view in position A.

### DESCRIPTION OF PREFERRED EMBODIMENTS

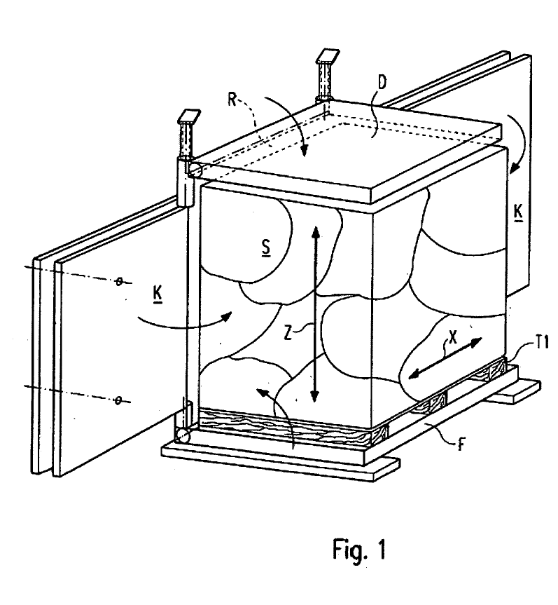

As is apparent in FIG. 1, a foot element F is provided which is arranged essentially horizontally. The foot element F carries a transport element T1 on which a stack S is stacked. The stack S consists of different products and extends essentially in a Z direction.

Adjacent to the foot element F, a rear wall R is also provided essentially in the Z direction. The rear wall R supports the stack S rearward. On the upper end of rear wall R, a fastening cover D is provided, which can be positioned from the top on the stack S. The fastening cover D is arranged pivotable around a horizontal axis, in which the axis should run parallel to the rear wall R.

On both sides of stack S two clamping jaws K are provided which are aligned essentially in the Z direction. The clamping jaws K, as is particularly apparent in FIG. 3, are pivotable around the two pivot axes 40 running in the Z direction so they come to lie on the side surfaces of stack S. With the clamping jaws K pivoted in, the stack S is grasped on its rear side by the rear wall R, on the two right and left sides by the clamping jaws K, on the top by the fastening cover D and on its bottom by the transport element T1 or foot element F.

As is also apparent in the top view according to FIG. 3, clamping jaws K can be moved linearly in an X direction, which runs perpendicular to the Z direction and parallel to rear wall R. In this manner the clamping jaws K can also be brought linearly to the stack S after they have already been aligned parallel to the stack side walls by pivoting around axes 40.

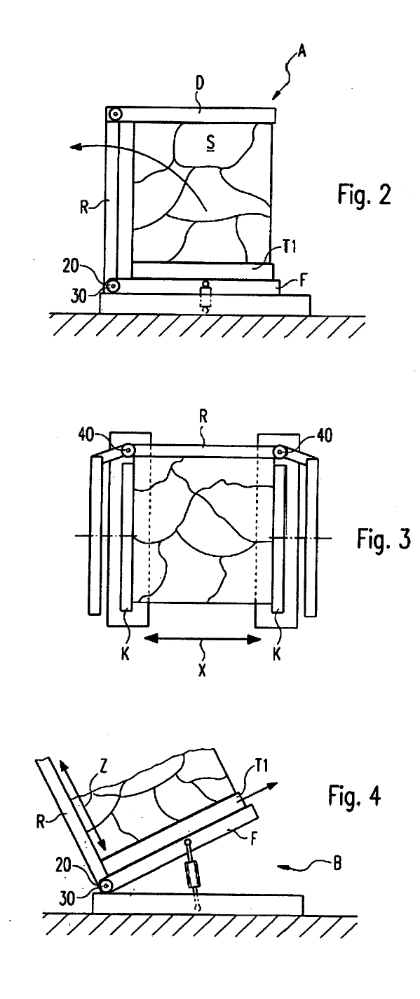

The side view of the stack in the initial position A can be seen in FIG. 2. The foot element F, on which the transport element T1 is mounted, is clearly apparent. A horizontally arranged axis 20 is also apparent, around which the stack S and the components grasping the stack can be pivoted relative to a base platform into a tilted position B.

The tilted position B is shown in FIG. 4. The rear wall R and the foot element F are therefore pivoted together around axis 20.

An axis 30 around which the foot element can be pivoted relative to rear wall R is also apparent in FIGS. 2 and 3. In the depicted example the axes 20 and 30 lie one on the other. However, a different arrangement of the two axes is also conceivable so that the apparatus can be pivoted around a different axis than the foot element relative to rear wall R.

In the tilted position B, when the stack S slopes partly against rear wall R, the foot element F can be pivoted out from the bottom of the stack S by an amount so that the transport element T1 (as shown in FIG. 4) can be removed from beneath the stack without collapse of the stack. By insertion of another transport element at the same location and pivoting the foot element F back, the stack S is stabilized again from below so that it can be brought back to its upright position when the complete apparatus is pivoted back around axis 20.

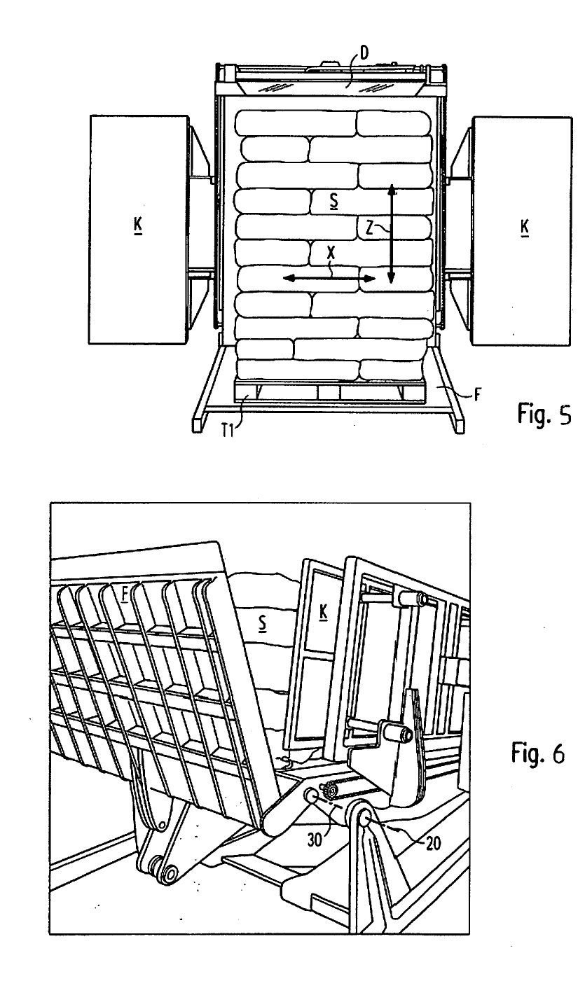

The reloading apparatus can be seen from the front in FIG. 5. The two clamping jaws K in the unapplied state can be seen to the right and left of stack S. The stack S is grasped on its top by the fastening cover D and on its bottom by the transport element T1, which lies on the foot element F.

FIG. 6 shows a schematic oblique view in the tilted position B. The now horizontally lying stack S is grasped laterally by the two clamping jaws K (only one of which can be seen in FIG. 6). The foot element F is tilted away from the former bottom of stack S around axis 30 and the transport element is removed.

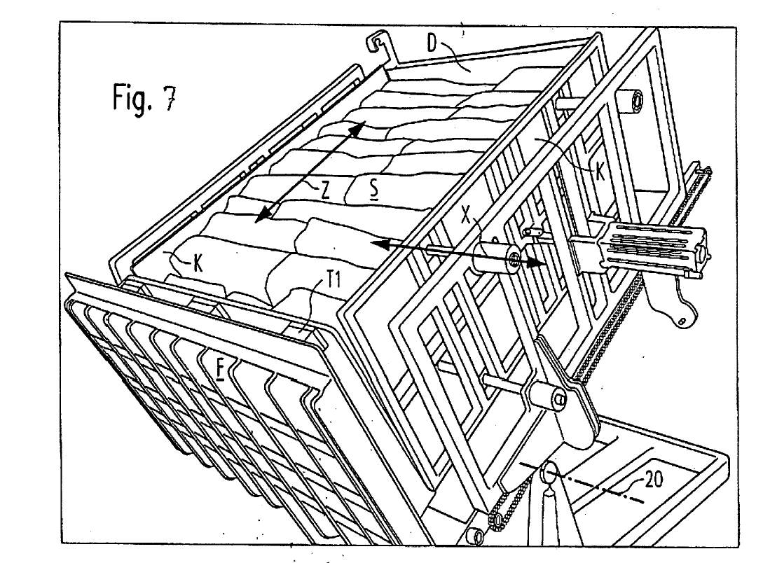

FIG. 7 shows the reloading apparatus in a position altered relative to the initial position A. This can be the sought tilted position B or a position between the initial position A and the tilted position B.

The clamping jaws K grasp the stack S from two opposite sides. The clamping jaws K are moved toward the stack for this purpose in the X direction. The stack S is grasped in the Z direction via a transport element T1 lying on the foot element F and the fastening cover D.

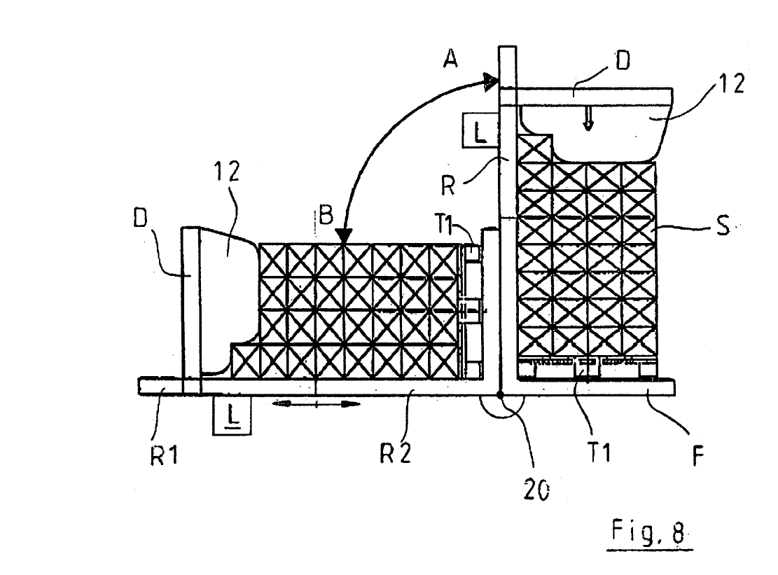

FIG. 8 shows a reloading apparatus in the initial position A and in a tilted position B perpendicular to it. In the initial position A, the stack S rests on the transport element T1. The top of the stack is stabilized by the fastening cover D in conjunction with a balancing element 12 designed as an airbag.

The stack S is also shown in the essentially horizontal tilted position B which it enters by pivoting around axis 20 from the initial position A.

The rear wall R is divided into two wall elements R1 and R2, which can be moved relative to each other in the longitudinal direction of the rear wall R in the direction of the indicated arrow. By separation of the two wall elements R1 and R2 a gap is formed at the separation site into which a separation element or also a transport element can be inserted.

A vibrating element L is also arranged in the region of rear wall R in order to align the individual components of the stack or arrange them by controllable vibrations.

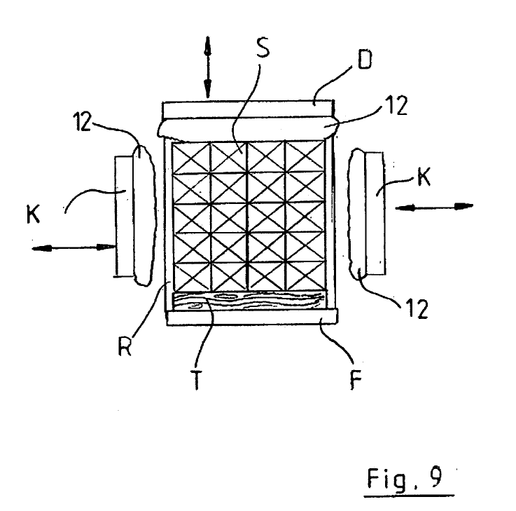

An reloading apparatus is depicted in FIG. 9 in the initial position A viewed from the front schematically. It is readily apparent that balancing elements 12 are arranged between the clamping jaws K and the stack S and the fastening cover D and stack S and should stabilize the stack from at least three sides after the clamping jaws and the fastening cover have been moved onto the stack.

1.-16. (canceled)

17. Method for rearrangement of stacks and for changing the transport elements under stacked products according to the following process steps:
(a) fastening of a product stack (S) resting in an initial position (A) on a first transport element (T1) between the first transport element on the lower end of the stack (S) and fastening cover (D) provided on the opposite upper end of the stack (S), wherein the first transport element (T1) lies on a foot element (F);
(b) clamping of the stack between at least two additional opposite side surfaces by at least two clamping jaws (K);
(c) pivoting and/or displacement of the foot element (F) away from the bottom of the stack (S) so that the first transport element is released;
(d) replacement of the first transport element (T1) with a second transport element (T2);
(e) reversal of the movements of the foot element (F) mentioned in step c) so that the second transport element (T2) can be placed on the lower end of stack (S);
(f) loosening of the fastenings and clampings according to step a) and b);

18. Method according to claim 17, characterized by the fact that between step (b) and (c) for unloading of the first transport element (T1) and foot element (F), pivoting of the entire stack (S) occurs around an essentially horizontal axis (20) into a tilted position (B) and a pivot movement opposite this occurs between step (e) and (f).

19. Method according to claim 18, characterized by the fact that the stack is arranged essentially horizontally in the tilted position (B).

20. Method according to claim 19, characterized by the fact that the stack in the tilted position (B) is divided into two stacks by displacement of the rear wall (R) divisible into at least two wall elements (R1, R2) in order to insert a separation or transport element in between or remove one.

21. Method according to claim 20, characterized by the fact that the clamping jaws are released for the stack division process.

22. Method according to claim 17 characterized by the fact that some of the steps overlap in time.

23. Reloading apparatus for rearrangement of products stacked on transport elements and replacement of transport elements, including:
(a) a rear wall (R) with a lower and an upper end, in which the rear wall (R) runs in a direction (Z) and the direction (Z) is essentially vertically aligned in an initial position (A);
(b) a foot element (F) adjacent to the lower end of rear wall (R) to accommodate a product stack (S) arranged on a first transport element (T1), wherein the foot element (F) can be pivoted around a pivot axis (30) running parallel to rear wall (R) and/or can be displaced in the direction (Z);
(c) with a fastening cover (D) arranged on the upper end of the rear wall (R), moveable in the (Z) direction and/or pivotable around an axis for clamping of the stack (S) in direction (Z) between fastening cover (D) and foot element (F); and
(d) with at least two side clamping jaws (K) to clamp the stack from the right and left between clamping jaws (K).

24. Reloading apparatus according to claim 23, characterized by the fact that the apparatus can be pivoted around a tilting axis (20) running parallel to rear wall (R) from the initial position (A) into a tilted position (B).

25. Reloading apparatus according to claim 23, characterized by the fact that the rear wall (R) can be divided into at least two wall elements (R1, R2) moveable relative to one another.

26. Reloading apparatus according to claim 23, characterized by the fact that the apparatus can be moved in a vertical direction from an initial position to a lift position (H).

27. Reloading apparatus according to claim 23, characterized by the fact that the fastening cover (D) and/or the clamping jaws (K) have balancing elements (12), especially airbags or cushions for balancing of unevenness in the stack side surfaces or on the top of the stack.

28. Reloading apparatus according to claim 23, characterized by the fact that the foot element (F) in the initial position (A), the tilted position (B), the lifting position (H) and/or in any position in between can be pivoted away from the stack (S) around axis (30) or can be moved in direction (Z).

29. Reloading apparatus according to claim 23, characterized by the fact that
(a) the lateral clamping jaws (K) can be individually pivoted to or away from the sides of the stack (S) around an axis (40) running essentially in direction (Z); and
(b) that the lateral clamping jaws (K) can be moved toward or away from the sides of the stack (S) in a direction (X) perpendicular to direction (Z).

30. Reloading apparatus according to claim 23, characterized by the fact that a vibrating element (L) is provided with which the stack can be placed in vibration preferably in the tilted position (B) for realignment of individual elements of the stack.

31. Reloading apparatus according to claim 23, characterized by the fact that the tilted position (B) corresponds to a position rotated around axis (20) by 180° from the initial position (A).

32. Reloading apparatus according to claim 23, characterized by the fact that drives for movements of the clamping jaws (K) and/or the foot element (F) and/or the apparatus as well as a control of these drives are provided.
